(19) United States
(12) Patent Application Publication
(10) Pub. No.: US 2026/0173214 A1
(43) Pub. Date: Jun. 18, 2026

(54) PERIODIC ADVERTISING WITH RESPONSE WITH CAPABILITY FOR PERIPHERAL INITIATED MESSAGES OVER A SYNCHRONIZED CHANNEL

(71) Applicant: QUALCOMM Incorporated, San Diego, CA (US)

(72) Inventors: Nicolas GRAUBE, Cambridge (GB); Robin ROBIN, Noida (IN); Deep Shikha AGGARWAL, Gurugram (IN); Randhir KUMAR, New Delhi (IN); Rahul SANGWAN, Charkhi Dadri (IN); Sonu LNU, Faridabad (IN); Xin WU, Shanghai (CN)

(21) Appl. No.: 19/125,284

(22) PCT Filed: Dec. 1, 2022
(86) PCT No.: PCT/CN2022/135859

§ 371 Date: Apr. 28, 2025

(51) Int. Cl. H04W 88/08

(52) U.S. Cl. CPC H04W 88/08

(57) ABSTRACT

Disclosed are systems, apparatuses, processes, and computer-readable media for wireless communications. For example, a network device can transmit, to a plurality of wireless communication devices, a periodic advertisement on a synchronized channel. The network device can receive, from one or more wireless communication devices of the plurality of wireless communication devices, one or more wireless communication device-initiated messages in one or more reserved response slots on the synchronized channel.

### FIELD OF THE DISCLOSURE

The present disclosure generally relates to wireless communications. For example, aspects of the present disclosure relate to periodic advertising with response (PAwR) with a capability for peripheral initiated messages over a synchronized channel.

### BACKGROUND OF THE DISCLOSURE

Short range wireless communication enables wireless communication over relatively short distances (e.g., within thirty meters). For example, BLUETOOTH® is a wireless technology standard for exchanging data over short distances using short-wavelength ultra-high frequency (UHF) radio waves from 2.4 gigahertz (GHz) to 2.485 GHz.

BLUETOOTH® Low Energy (BLE) is a form of BLUETOOTH® communication that allows for communication with devices running on low power. Such devices may include beacons, which are wireless communication devices that may use low-energy communication technology for positioning, proximity marketing, or other purposes. In some cases, such devices may serve as nodes (e.g., relay nodes) of a wireless mesh network that communicates and/or relays information to a managing platform or hub associated with the wireless mesh network.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. According to at least one illustrative example, a network device for wireless communication is provided. The network device includes at least one memory and at least one processor (e.g., configured in circuitry) coupled to the at least one memory and configured to: output, for transmission to a plurality of wireless communication devices, a periodic advertisement on a synchronized channel; and receive, from one or more wireless communication devices of the plurality of wireless communication devices, one or more wireless communication device-initiated messages in one or more reserved response slots on the synchronized channel.

In another example, a method of wireless communication performed at a network device is provided. The method includes: transmitting, by the network device to a plurality of wireless communication devices, a periodic advertisement on a synchronized channel; and receiving, by the network device from one or more wireless communication devices of the plurality of wireless communication devices, one or more wireless communication device-initiated messages in one or more reserved response slots on the synchronized channel.

In another example, a non-transitory computer-readable storage medium is provided that has stored thereon instructions which, when executed by one or more processors, cause the one or more processors to: output, for transmission to a plurality of wireless communication devices, a periodic advertisement on a synchronized channel; and receive, from one or more wireless communication devices of the plurality of wireless communication devices, one or more wireless communication device-initiated messages in one or more reserved response slots on the synchronized channel.

In another example, an apparatus for wireless communication is provided. The apparatus includes: means for transmitting, to a plurality of wireless communication devices, a periodic advertisement on a synchronized channel; and means for receiving, from one or more wireless communication devices of the plurality of wireless communication devices, one or more wireless communication device-initiated messages in one or more reserved response slots on the synchronized channel.

In another example, a wireless communication device for wireless communication is provided. The wireless communication device includes at least one memory and at least one processor coupled to the at least one memory and configured to: receive, from a network device, a periodic advertisement on a synchronized channel; and output, for transmission to the network device, a wireless communication device-initiated message in a reserved response slot on the synchronized channel.

In another example, a method of wireless communication performed at wireless communication device is provided. The method includes: receiving, by the wireless communication device from a network device, a periodic advertisement on a synchronized channel; and transmitting, by the wireless communication device to the network device, a wireless communication device-initiated message in a reserved response slot on the synchronized channel.

In another example, a non-transitory computer-readable storage medium is provided that has stored thereon instructions which, when executed by one or more processors, cause the one or more processors to: receive, from a network device, a periodic advertisement on a synchronized channel; and output, for transmission to the network device, a wireless communication device-initiated message in a reserved response slot on the synchronized channel.

In another example, an apparatus for wireless communication is provided. The apparatus includes: means for receiving, from a network device, a periodic advertisement on a synchronized channel; and means for transmitting, to the network device, a wireless communication device-initiated message in a reserved response slot on the synchronized channel.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which systems and/or methods described herein may be implemented, in accordance with some aspects of the present disclosure.

FIG. 2 is a diagram illustrating example components of a device, in accordance with some aspects of the present disclosure.

FIG. 3 is a signaling diagram illustrating example communication transmissions, in accordance with some aspects of the present disclosure.

FIG. 4 is a signaling diagram illustrating an example of communication transmissions between a network device and two groups of wireless communication devices, in accordance with some aspects of the present disclosure.

FIG. 5 is a signaling diagram illustrating an example of communication transmissions including a set of reserved slots for peripheral-initiated messages located at the start of a sequence of response slots, in accordance with some aspects of the present disclosure.

FIG. 6 is a signaling diagram illustrating an example of communication transmissions including a set of reserved slots for peripheral-initiated messages located at the end of a sequence of response slots, in accordance with some aspects of the present disclosure.

FIG. 7 is signaling diagram illustrating an example of communication transmissions between a network device and a group of wireless communication devices, in accordance with some aspects of the present disclosure.

FIG. 8 is a flow chart illustrating an example of a process for wireless communications at a network device, in accordance with some aspects of the present disclosure.

FIG. 9 is a flow chart illustrating an example of a process for wireless communications at a wireless communication device, in accordance with some aspects of the present disclosure.

FIG. 10 is a block diagram illustrating an example of a computing system, which may be employed by the disclosed systems and techniques for periodic advertising with response with capability for peripheral initiated messages over a synchronized channel, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

A system may include one or more wireless communication devices that are controlled by a network entity. For example, an electronic shelf label (ESL) system may include one or more wireless communication devices (e.g., ESLs) that are controlled by a network entity, such as a management entity (ME), via at least one network device, such as an access point (AP). In one or more examples, to facilitate control by the management entity, each ESL may have a wireless connection (e.g., a BLUETOOTH® Low Energy (BLE) connection or other connection) to an access point (AP) that is communicatively connected to the management entity (e.g., via the Internet, such as wirelessly, via an Ethernet connection, etc.). In some cases, commands from the management entity may be wirelessly transmitted to the ESLs by the access point. Responses or information from the ESLs may also be received by the access point and provided by the access point to the management entity. While examples are described herein using ESLs as illustrative examples of wireless communication devices, a management entity as an example of a network entity, and access points as examples of network devices, the systems and techniques described herein are applicable to any type of system or network.

In ESL systems, periodic Advertisements (PAs) are often utilized to provide regular and predictable payload transmissions from a central device (e.g., which may simply be referred to as a “central” and may be in the form of a network device, such as an access point) to one or more peripheral devices (e.g., which may each simply be referred to as a “peripheral” and may each be in the form of a wireless communication device, such as an ESL). For example, PAs can be used to issue information from a central device to multiple peripheral devices, which may be within one or more groups of peripheral devices. PAs are generally unidirectional (e.g., unidirectional transmissions) such that PAS are transmitted only one-way from a central device to one or more peripheral devices. Unfortunately, the unidirectionality of PAs prevents PAs to be able to operate as a basis of a true network.

Periodic Advertisement with Response (PAwR) can be used for ESL systems to provide bidirectionality (e.g., bidirectional transmissions between a central device and one or more peripheral devices). Peripheral devices synchronized within a particular group of peripheral devices can be addressed by a central device on a synchronized channel (e.g., a radio frequency (RF) channel between the central device and the peripheral devices) whenever the central device chooses to send (e.g., transmit) a request to the peripheral devices. In some cases, as used herein, a synchronized channel refers to a channel on which transmissions are synchronized (in time). For example, the channel includes a frequency on which one or more communications are transmitted. A hopping frequency sequence defines the channel, where the sequence progresses at a fixed determine interval. A central device and one or more peripheral devices can concurrently track the sequence at the predefined frequency hopping pattern (e.g., so the central device knows when to transmit the request and the peripheral devices know when to listen for and/or receive the request).

A request transmitted by a central device to peripheral devices in a particular group may be a PA containing a synchronization message transmitted by the central device on the synchronized channel to the peripheral devices of the particular group. For example, wireless communication devices within the particular group can wake up (e.g., from a low power (LP) mode) at the same PA transmission with respect to a particular PAwR train for that group. A PA is made up of a periodic set of transmissions, where the collection of transmissions is collectively referred to as a PA train or a PAwR train when applied to PAwR. Each transmission of a PA train (or PAwR train) occurs at a precise point in time, with fixed intervals between the transmissions. A communication channel (e.g., one communication channel out of thirty-seven available communication channels) is selected for each of the transmissions, where the communication channel follows a hopping frequency sequence. The synchronization between the central device and the peripheral devices in the group is based on the periodicity of the PA. The periodically-transmitted messages (e.g., the synchronization messages) include zero, one, or more commands (e.g., a respective operational code (OpCode) and parameters associated with each command). If a response from a particular peripheral device is expected by the central device (e.g., the synchronization message from the central device requests a response from a specific peripheral device), the peripheral device will respond in a specific response slot, based on where the peripheral device appeared within a sequence contained within the synchronization message transmitted by the central device.

However, the signaling arrangement of response slots on the synchronized channel can lead to peripheral devices needing to wait for the central device to request an update (e.g., request a response) from the peripheral devices for the peripheral devices to be able to provide updated data (e.g., via responses from the peripheral devices in the response slots) to the central device on the synchronized channel. As such, to send a peripheral-initiated message (e.g., a wireless communication device-initiated message) from a peripheral device to the central device, the peripheral device cannot use the synchronized channel. Rather, to transmit peripheral-initiated messages to a central device, peripheral devices are dependent on using non-connectable advertisements on extremely crowded legacy channels (e.g., the legacy advertisement channel) located outside of the synchronized channel between the central device and the peripheral devices.

Systems and techniques are described herein for providing periodic advertising with response (PAwR) with capability for peripheral-initiated messages over a synchronized channel. For example, the systems and techniques provide a solution to allow peripheral devices to be able to send (e.g., transmit) peripheral-initiated messages over a synchronized channel between a central device and the peripheral devices. In one or more examples, a configurable number of response slots in the synchronized channel can be reserved for peripheral-initiated messages such that peripheral devices are able to send messages (e.g., peripheral-initiated messages) to the central device at will by using these reserved response slots. In one or more examples, the response slots can be reserved statically by a static allocation (e.g., specific response slots can be statically reserved to be used only for peripheral-initiated messages) or dynamically by a dynamic allocation (e.g., response slots the central device is not expecting responses can be dynamically reserved to be used for peripheral-initiated messages). In some examples, the reserved response slots for peripheral-initiated messages may be located anywhere within the sequence of response slots (e.g., the sequence of response slots specified within the synchronization message from the central device).

In some aspects, a peripheral device may transmit a peripheral-initiated message in a reserved response slot from a number of response slots reserved for a group in which the peripheral device belongs. In other aspects, a peripheral device belonging to a first group may transmit a peripheral-initiated message using response slots reserved for one or more other groups of peripheral devices. For instance, the peripheral device from the first group can transmit a peripheral-initiated message in a reserved response slot from a number of response slots reserved for a second group (e.g., without waiting for an AP synchronization message for its own group). Such aspects are possible based on the peripheral device being aware that central device would be listening for peripheral-initiated messages in the reserved response slots for the second group.

One advantage of the systems and techniques described herein is to avoid spectral congestion on a legacy advertisement channel, as well as maintaining an internal scheduling of a peripheral device (e.g., an ESL), which can allow a peripheral device to maintain a low-power mode even for peripheral-initiated messages. Another advantage is that the need for separate non-connectable advertisement is avoided by using the systems and techniques described herein. Yet another advantage of the systems and techniques is that, by having reserved slots for peripheral-initiated messages, a peripheral device can control the point in time when the peripheral device transmits information to a central device, instead of having to wait for a request from the central device and/or to wait for the central device to start scanning for legacy channels.

Additional aspects of the present disclosure are described in more detail below.

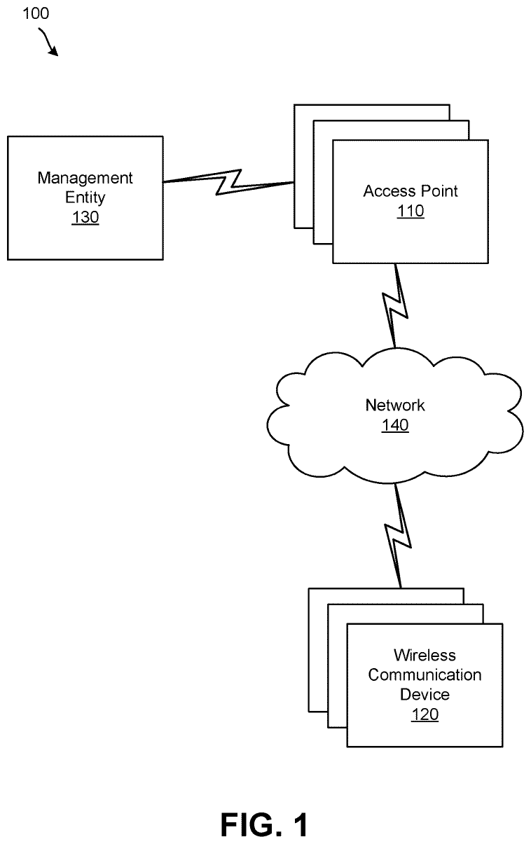

FIG. 1 is a diagram of an example environment 100 in which systems and/or methods described herein may be implemented. As shown in FIG. 1, the environment 100 may include at least one access point (AP) 110, at least one wireless communication device 120, a management entity (ME) 130, and a network 140. Devices of the environment 100 may interconnect via wired connections, wireless connections, or a combination of wired and wireless connections.

The access point 110 may include one or more devices capable receiving, generating, storing, processing, providing, and/or routing information associated with access point synchronization and/or handover, as described elsewhere herein. The access point 110 may include a communication device and/or a computing device. The access point 110 may be configured to transmit beacons (e.g., BLE beacons), as well as to scan and locate other devices (e.g., other devices communicating using BLE protocols).

The wireless communication device 120 may include one or more devices capable of receiving, generating, storing, processing, and/or providing information associated with access point synchronization and/or handover, as described elsewhere herein. The wireless communication device 120 may include a communication device and/or a computing device. In some aspects, the wireless communication device 120 may be, may include, or may be included in an electronic shelf label (ESL).

The management entity 130 includes one or more devices capable of receiving, generating, storing, processing, providing, and/or routing information associated with access point synchronization and/or handover, as described elsewhere herein. The management entity 130 may include a communication device and/or a computing device. For example, the management entity 130 may include a server, such as an application server, a client server, a web server, a database server, a host server, a proxy server, a virtual server (e.g., executing on computing hardware), or a server in a cloud computing system. In some aspects, the management entity 130 includes computing hardware used in a cloud computing environment. The management entity 130 may provide control of a system (e.g., an ESL system) that includes the access point(s) 110, the wireless communication device(s) 120, and/or the device(s) 130. The access point(s) 110 may be communicatively connected to the management entity 130 via a network (not shown), such as the Internet.

The network 140 may include one or more wireless networks. For example, the network 140 may include a personal area network (e.g., a Bluetooth network). The network 140 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

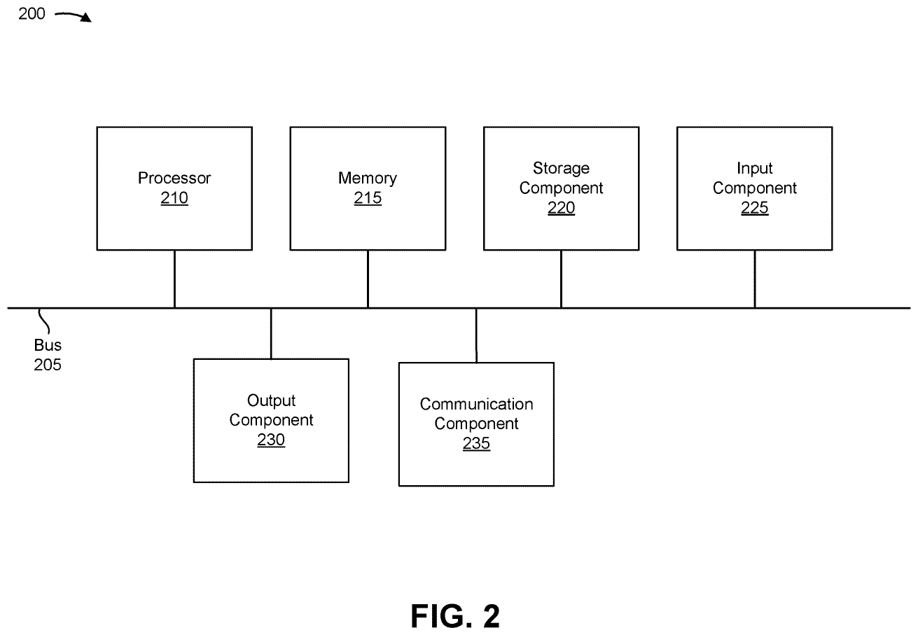

FIG. 2 is a diagram illustrating example components of a device 200, in accordance with the present disclosure. Device 200 may correspond to access point 110, wireless communication device 120, and/or management entity 130. In some aspects, access point 110, wireless communication device 120, and/or management entity 130 may include one or more devices 200 and/or one or more components of device 200. As shown in FIG. 2, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

As previously mentioned, in ESL systems, PAs are often utilized to provide regular and predictable payload transmissions from a central device (e.g., which may be in the form of a network device, such as an access point) to one or more peripheral devices (e.g., which may each be in the form of a wireless communication device, such as an ESL). PAs can be used to issue information from a central device to multiple peripheral devices, which may be within one or more groups of peripheral devices. PAs are generally unidirectional (e.g., unidirectional transmissions) such that PAs are transmitted only one-way from a central device to one or more peripheral devices.

Periodic Advertisement with Response (PAwR) can be used by ESL systems to provide bidirectionality (e.g., bidirectional transmissions between a central device and one or more peripheral devices). Peripheral devices synchronized within a group of peripheral devices can be addressed by a central device on a synchronized channel (e.g., a synchronized frequency channel between the central device and the peripheral devices) whenever the central device chooses to send (e.g., transmit) a request (e.g., a PA containing a synchronization message transmitted on the synchronized channel) to the peripheral devices. If a response from a peripheral device is expected by the central device (e.g., the synchronization message from the central device requests a response from a specific peripheral device), the particular peripheral device will respond in a specific response slot, based on where the peripheral device appeared within a sequence contained within the synchronization message transmitted by the central device.

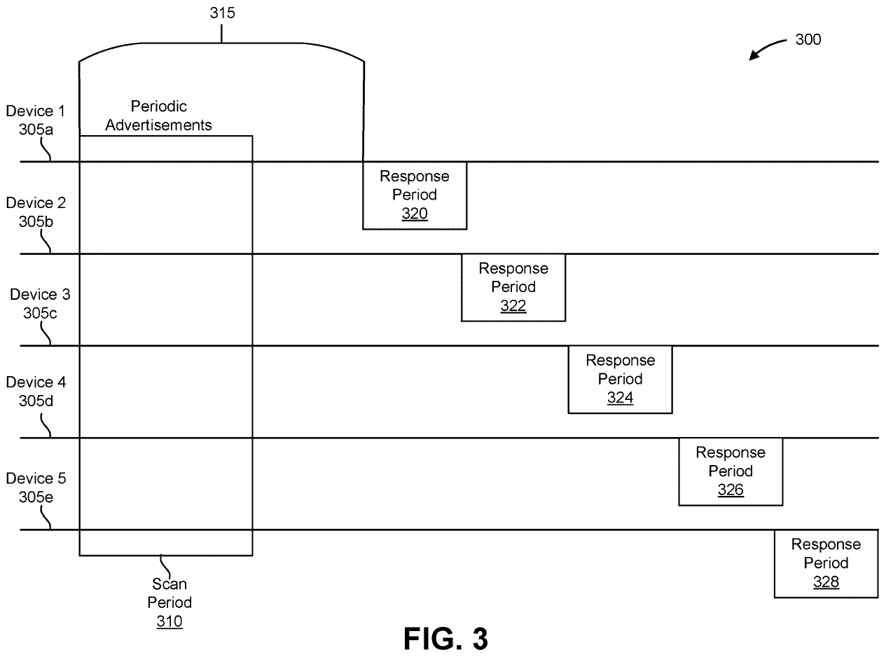

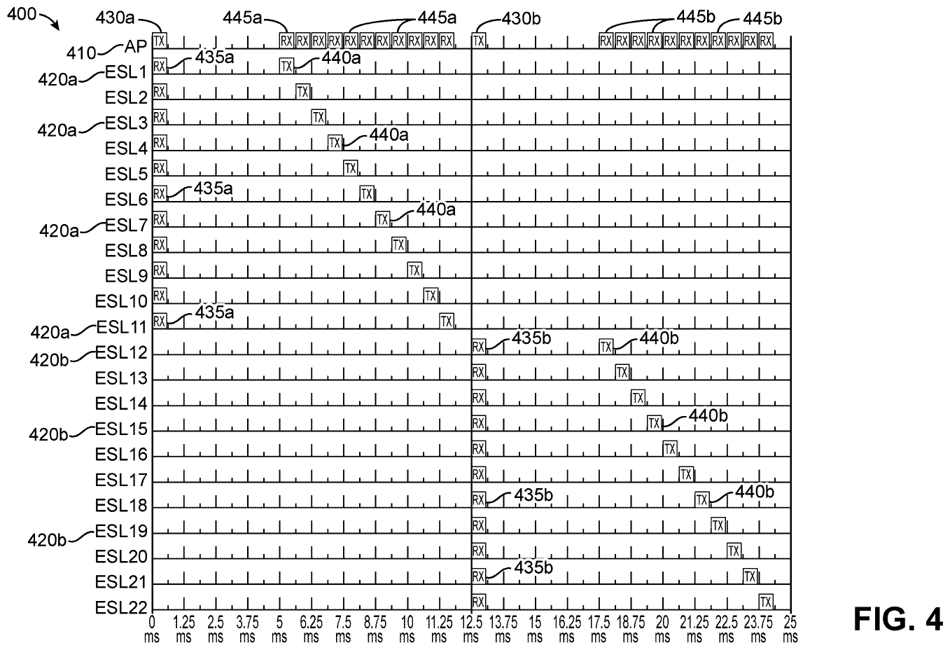

FIGS. 3 and 4 show signaling diagrams illustrating examples of PAwR in an ESL system. In particular, the signaling diagram of FIG. 3 shows an example PAwR for a group of wireless network devices (e.g., device 1 305a, device 2 305b, device 3 305c, device 4 305d, and device 5 305e), and the signaling diagram of FIG. 4 shows an example PAwR for two groups of wireless network devices 420a, 420b (e.g., a first group including ESL1 to ESL 11, and a second group including ESL 12 to ESL 22). In particular, FIG. 3 is a signal timing diagram illustrating a portion of a communication between an access point (e.g., access point 110) and wireless communication devices 120 (e.g., ESLs). With reference to FIG. 1, the signal sequence illustrated in FIG. 3 may be implemented by one or more of the communication connections, access points 110, and/or wireless communication devices 120 of FIG. 1.

The devices (e.g., device 1 305a, device 2 305b, device 3 305c, device 4 305d, and device 5 305e) of FIG. 3 may be selected from wireless communication devices 120 of FIG. 1, and may each receive a periodic advertisement (PA) in a scan period 310. The scan period 310 may occur in regularly scheduled intervals and may be repeated periodically such that the devices (e.g., device 1 305a, device 2 305b, device 3 305c, device 4 305d, and device 5 305e) can awaken to scan for messages during this repeated scan period 310. An access point (e.g., access point 110 of FIG. 1) may provide periodic advertisements (PAS) via broadcast or multi-cast to the devices (e.g., device 1 305a, device 2 305b, device 3 305c, device 4 305d, and device 5 305e) in the scan period 310. For an access point (e.g., access point 110 of FIG. 1), the scan period 310 can be its primary transmission period. In some cases, the scan period 310 may not be a fixed time because the access point (e.g., access point 110 of FIG. 1) may send different lengths of data from the start of the scan period 310.

The transmission may include multiple advertisements in a train. One or more portions of the advertisements may be directed to one or more of the devices (e.g., device 1 305a, device 2 305b, device 3 305c, device 4 305d, and device 5 305e). The devices (e.g., device 1 305a, device 2 305b, device 3 305c, device 4 305d, and device 5 305e) may decode or filter the messages intended for each specific device and transmitted during the period when all devices are receiving. In this way, the devices (e.g., device 1 305a, device 2 305b, device 3 305c, device 4 305d, and device 5 305e) may be reprogrammed, updated, and/or sent requests from an access point (e.g., access point 110 of FIG. 1) or relayed from another device (e.g., management entity 130 of FIG. 1) through the access point (e.g., access point 110 of FIG. 1). The periodic advertisement (PA) from the access point (e.g., access point 110 of FIG. 1) may set a response period for one or more of the devices (e.g., device 1 305a, device 2 305b, device 3 305c, device 4 305d, and device 5 305e).

As illustrated, the devices (e.g., device 1 305a, device 2 305b, device 3 305c, device 4 305d, and device 5 305e) are each assigned a response period 320, 322, 324, 326, 328 in the time after the scan period 310. In some cases, the assignment of the response period to a particular device may not be permanent. In some aspects, the assignment may be inferred from a payload of a synchronization message. The first response period 320 may begin following an idle time 315 after the scan period 310, with the idle period being long enough to provide the transmitter device an opportunity to do other Bluetooth related activities. The assigned response periods may also be limited to or designate a particular frequency of the channels on which to respond. For example, in FIG. 3, device 1 305a is assigned response period 320, device 2 305b is assigned response period 322, device 3 305c is assigned response period 324, device 4 305d is assigned response period 326, and device 5 305e is assigned response period 328. The access point (e.g., access point 110 of FIG. 1) may store attributes of the devices (e.g., device 1 305a, device 2 305b, device 3 305c, device 4 305d, and device 5 305e), including whether a device is able to transmit or respond. The PA signaling followed by responses can be referred to as periodic advertisement with multiple responses (PAwMR).

For example, device 3 305c (e.g., wireless communication device 120 of FIG. 1) may be an ESL and may receive a price update in a PA from the access point (e.g., access point 110 of FIG. 1) in scan period 310. The PA received at device 3 305c may include a designated start time for the response period 324 or may include a schedule of response start times for devices including device 3 305c. The response by device 3 305c to the access point (e.g., access point 110 of FIG. 1) may include an acknowledgement, a status code, and/or other information such as battery life, received signal strength, and/or an error notification. The response by device 3 305c may include information to be relayed to another device by the access point (e.g., access point 110 of FIG. 1). The response may include a packet with a header and may conform to any of the Bluetooth protocols. A response may be transmitted in a data channel of the Bluetooth protocol to the access point (e.g., access point 110 of FIG. 1). Both the PA and the responses from all of the devices (e.g., device 1 305a, device 2 305b, device 3 305c, device 4 305d, and device 5 305e) may use channels of the Bluetooth protocol.

A device (e.g., device 5 305e) that has been assigned a response period may not respond and may determine that it has nothing to signal. In other words, the devices (e.g., device 1 305a, device 2 305b, device 3 305c, device 4 305d, and device 5 305e) may determine what response, if any, is required and may or may not respond to a request sent from the access point (e.g., access point 110 of FIG. 1). The response periods 320, 322, 324, 326, 328 may be assigned based on a request for such a period in an open transmission time, the request being sent to the access point (e.g., access point 110 of FIG. 1). The response periods 320, 322, 324, 326, 328 may be assigned based on which devices have been requested by the access point (e.g., access point 110 of FIG. 1) to send data or acknowledgements. The PA messages and responses may be frequency-hopped, time synchronized channels, and/or extended channels of the advertising channels in Bluetooth.

As previously mentioned, FIG. 4 shows an example PAwR for two groups of wireless network devices 420a, 420b (e.g., a first group including ESL1 to ESL 11, and a second group including ESL 12 to ESL 22). In particular, FIG. 4 is a signaling diagram illustrating an example of communication transmissions 400 between a network device 410 (e.g., a central device, which may be an access point) and two groups of wireless communication devices 420a, 420b (e.g., peripheral devices, which may be ESLs). With reference to FIG. 1, the signal sequence illustrated in FIG. 4 may be implemented by one or more of the communication connections, access points 110, and/or wireless communication devices 120 of FIG. 1.

In FIG. 4, the signaling diagram is shown in the form of a graph with an x-axis denoting time in milliseconds (ms) and a y-axis denoting specific wireless communication devices 420a, 420b (e.g., ESL1, ESL 2, ESL 3, ESL 4, ESL 5, ESL 6, ESL 7, ESL 8, ESL 9, ESL 10, ESL 11, ESL 12, ESL 13, ESL 14, ESL 15, ESL 16, ESL 17, ESL 18, ESL 19, ESL 20, ESL 21, and ESL 22). In particular, the x-axis of the graph of FIG. 4 denotes time starting from 0 ms and ending at 25 ms. The time can be divided into two subframes, which are each a length of 12.5 ms. As such, the two subframes may include a first subframe from 0 ms to 12.5 ms, and a second subframe from 12.5 ms to 25 ms. In one or more examples, there may be more or less than two subframes as is shown in FIG. 4, and/or each subframe may be longer or shorter than 12.5 ms as shown in FIG. 4.

In one or more examples, the wireless communication devices 420a, 420b (e.g., peripheral devices) may be assigned (e.g., by the network device 410 and/or by a network entity, such as a management entity) to different groups (e.g., two groups) of wireless communication devices 420a, 420b. For example, wireless communication devices 420a (e.g., ESL1, ESL 2, ESL 3, ESL 4, ESL 5, ESL 6, ESL 7, ESL 8, ESL 9, ESL 10, and ESL 11) may be assigned to a first group (e.g., group 1), and wireless communication devices 420b (e.g., ESL 12, ESL 13, ESL 14, ESL 15, ESL 16, ESL 17, ESL 18, ESL 19, ESL 20, ESL 21, and ESL 22) may be assigned to second group (e.g., group 2).

In FIG. 4, during operation for PAwR, at time 0 ms for the first subframe of time, the network device 410 (e.g., a central, such as an AP) may transmit 430a to a first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) a PA containing a synchronization message (e.g., an AP synchronization message) over a synchronized channel between the network device 410 and the wireless communication devices 420a, 420b. As noted previously, a synchronization message can include one or more commands. For instance, a command can include an operational code (OpCode) and parameters associated with the command. At time 0 ms, the first group of wireless communication devices 420a (e.g., ESL 1, ESL 2, ESL 3, ESL 4, ESL 5, ESL 6, ESL 7, ESL 8, ESL 9, ESL 10, and ESL 11) can receive 435a the PA containing the synchronization message over the synchronized channel.

In one or more examples, the network device 410 may be configured to transmit PAs at a specified time interval (e.g., a subframe of time), such as at every 12.5 ms as is shown in FIG. 4. In one or more examples, the specified time interval (e.g., a subframe) may be shorter or longer than the 12.5 ms as is shown in FIG. 4. The wireless communication devices 420a, 420b may respond to a PA by using their specific respective response slot in time.

In one or more examples, the synchronization message transmitted 430a to the first group (e.g., group 1) of wireless communication devices 420a (e.g., ESL 1, ESL 2, ESL 3, ESL 4, ESL 5, ESL 6, ESL 7, ESL 8, ESL 9, ESL 10, and ESL 11) may indicate a respective response slot for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) in the first group to use to transmit 440a a response to the network device 410. If a wireless communication device 420a (e.g., ESL 1, ESL 2, ESL 3, ESL 4, ESL 5, ESL 6, ESL 7, ESL 8, ESL 9, ESL 10, and ESL 11) is addressed within the synchronization message, the wireless communication device 420a (e.g., ESL 1, ESL 2, ESL 3, ESL 4, ESL 5, ESL 6, ESL 7, ESL 8, ESL 9, ESL 10, and ESL 11) can respond (e.g., transmit 440a) in its respective response slot, as indicated within the synchronization message.

For example, the synchronization message may indicate a specific sequence for one or more of the wireless communication devices 420a (e.g., ESL 1, ESL 2, ESL 3, ESL 4, ESL 5, ESL 6, ESL 7, ESL 8, ESL 9, ESL 10, and/or ESL 11) to respond (e.g., transmit 440a) in time (e.g., responding after 5 ms has elapsed after the start of the subframe at response slots located every 0.625 ms). For example, the sequence may indicate that wireless communication device 420a (e.g., ESL 1) should respond in a response slot located at 5 ms, wireless communication device 420a (e.g., ESL 2) should respond in a response slot located at 5.625 ms, wireless communication device 420a (e.g., ESL 3) should respond in a response slot located at 6.25 ms, wireless communication device 420a (e.g., ESL 4) should respond in a response slot located at 6.875 ms, wireless communication device 420a (e.g., ESL 5) should respond in a response slot located at 7.5 ms, wireless communication device 420a (e.g., ESL 6) should respond in a response slot located at 8.125 ms, wireless communication device 420a (e.g., ESL 7) should respond in a response slot located at 8.75 ms, wireless communication device 420a (e.g., ESL 8) should respond in a response slot located at 9.375 ms, wireless communication device 420a (e.g., ESL 9) should respond in a response slot located at 10 ms, wireless communication device 420a (e.g., ESL 10) should respond in a response slot located at 10.625 ms, and wireless communication device 420a (e.g., ESL 11) should respond in a response slot located at 11.25 ms.

After the wireless communication devices 420a (e.g., ESL 1, ESL 2, ESL 3, ESL 4, ESL 5, ESL 6, ESL 7, ESL 8, ESL 9, ESL 10, and ESL 11) have received 435a the PA containing the synchronization message from the network device 410, according to the sequence specified within the synchronization message, the one or more wireless communication devices 420a (e.g., ESL 1, ESL 2, ESL 3, ESL 4, ESL 5, ESL 6, ESL 7, ESL 8, ESL 9, ESL 10, and/or ESL 11) can transmit 440a their responses within their respective response slots. After the one or more wireless communication devices 420a (e.g., ESL 1, ESL 2, ESL 3, ESL 4, ESL 5, ESL 6, ESL 7, ESL 8, ESL 9, ESL 10, and/or ESL 11) have transmitted 440a their responses in their respective time slots, the network device 410 can receive 445a their transmitted responses at those specific response slot times.

Then, during operation for PAwR, at time 12.5 ms for the second subframe of time, the network device 410 may transmit 430b to a second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) a PA containing a synchronization message over a synchronized channel between the network device 410 and the wireless communication devices 420a, 420b. In addition, at time 12.5 ms, the second group of wireless communication devices 420b (e.g., ESL 12, ESL 13, ESL 14, ESL 15, ESL 16, ESL 17, ESL 18, ESL 19, ESL 20, ESL 21, and ESL 22) can receive 435b the PA containing the synchronization message over the synchronized channel.

The synchronization message transmitted 430b to the second group (e.g., group 2) of wireless communication devices 420b (e.g., ESL 12, ESL 13, ESL 14, ESL 15, ESL 16, ESL 17, ESL 18, ESL 19, ESL 20, ESL 21, and ESL 22) may indicate a respective response slot for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) in the second group to use to transmit 440b a response to the network device 410. If a wireless communication device 420b (e.g., ESL 12, ESL 13, ESL 14, ESL 15, ESL 16, ESL 17, ESL 18, ESL 19, ESL 20, ESL 21, and ESL 22) is addressed within the synchronization message, the wireless communication device 420b (e.g., ESL 12, ESL 13, ESL 14, ESL 15, ESL 16, ESL 17, ESL 18, ESL 19, ESL 20, ESL 21, and ESL 22) can respond (e.g., transmit 440b) in its respective response slot, as indicated within the synchronization message.

For example, the synchronization message may indicate a specific sequence for one or more of the wireless communication devices 420b (e.g., ESL 12, ESL 13, ESL 14, ESL 15, ESL 16, ESL 17, ESL 18, ESL 19, ESL 20, ESL 21, and/or ESL 22) to respond (e.g., transmit 440b) in time (e.g., responding after 5 ms has elapsed after the start of the subframe at response slots located every 0.625 ms). For example, the sequence may indicate that wireless communication device 420b (e.g., ESL 12) should respond in a response slot located at 17.5 ms, wireless communication device 420b (e.g., ESL 13) should respond in a response slot located at 18.125 ms, wireless communication device 420b (e.g., ESL 14) should respond in a response slot located at 18.75 ms, wireless communication device 420b (e.g., ESL 15) should respond in a response slot located at 19.375 ms, wireless communication device 420b (e.g., ESL 16) should respond in a response slot located at 20 ms, wireless communication device 420b (e.g., ESL 17) should respond in a response slot located at 20.625 ms, wireless communication device 420b (e.g., ESL 18) should respond in a response slot located at 21.25 ms, wireless communication device 420b (e.g., ESL 19) should respond in a response slot located at 21.875 ms, wireless communication device 420b (e.g., ESL 20) should respond in a response slot located at 22.5 ms, wireless communication device 420b (e.g., ESL 21) should respond in a response slot located at 23.125 ms, and wireless communication device 420b (e.g., ESL 22) should respond in a response slot located at 23.75 ms.

After the wireless communication devices 420b (e.g., ESL 12, ESL 13, ESL 14, ESL 15, ESL 16, ESL 17, ESL 18, ESL 19, ESL 20, ESL 21, and ESL 22) have received 435b the PA containing the synchronization message from the network device 410, according to the sequence specified within the synchronization message, the one or more wireless communication devices 420b (e.g., ESL 12, ESL 13, ESL 14, ESL 15, ESL 16, ESL 17, ESL 18, ESL 19, ESL 20, ESL 21, and/or ESL 22) may transmit 440b their responses within their respective response slots. After the one or more wireless communication devices 420b (e.g., ESL 12, ESL 13, ESL 14, ESL 15, ESL 16, ESL 17, ESL 18, ESL 19, ESL 20, ESL 21, and/or ESL 22) have transmitted 440b their responses in their respective time slots, the network device 410 can receive 445b their transmitted responses at those specific response slot times. Then, the PAwR may continue similarly for subsequent subframes of time.

As previously mentioned, PAwR does not provide an opportunity for a wireless communication device (e.g., wireless communication device 420a, 420b, a peripheral device, such as an ESL) to send (e.g., transmit) a peripheral-initiated message over the synchronized channel to a network device (e.g., network device 410, a central device, such as an access point). In one or more aspects, the systems and techniques provide PAwR with capability for peripheral-initiated messages over a synchronized channel. The systems and techniques provide a solution to allow peripheral devices (e.g., wireless communication devices 420a, 420b of FIG. 4 in the form of ESLs) to be able to send (e.g., transmit) peripheral-initiated messages over a synchronized channel between a central device (e.g., network device 410 of FIG. 4 in the form of an access point) and the peripheral devices. In one or more aspects, a configurable number of response slots in the synchronized channel may be reserved for peripheral-initiated messages such that peripheral devices are able to send messages (e.g., peripheral-initiated messages) to the central device at will by using these reserved response slots. The response slots may be reserved statically by a static allocation (e.g., specific response slots can be statically reserved to be used only for peripheral-initiated messages) or dynamically by a dynamic allocation (e.g., response slots the central device is not expecting responses can be dynamically reserved to be used for peripheral-initiated messages). The reserved response slots for peripheral-initiated messages may be located anywhere within the sequence of response slots (e.g., the sequence of response slots specified within the synchronization message from the central device).

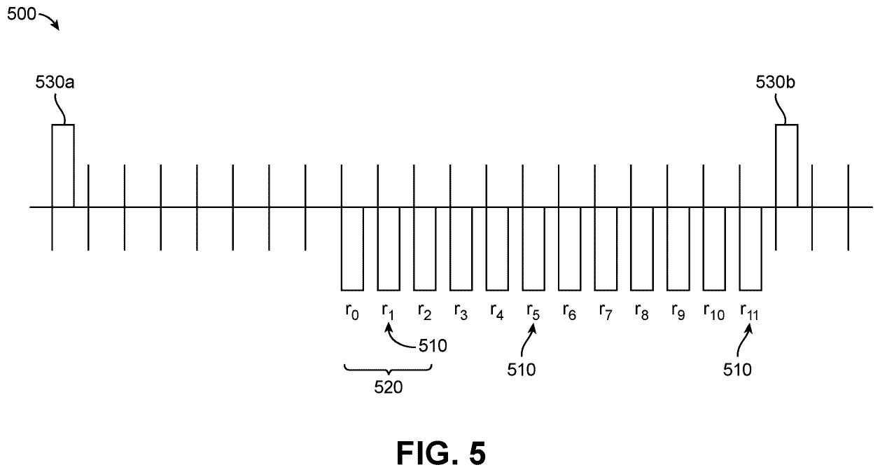

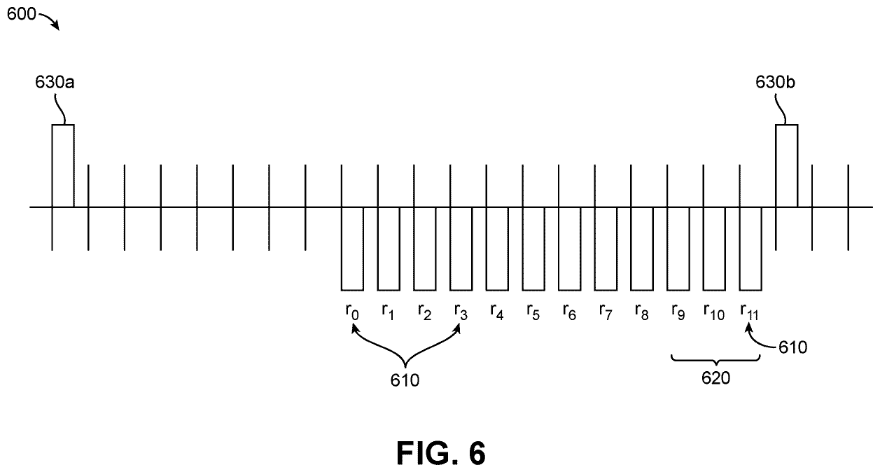

FIGS. 5 and 6 each show a set of reserved slots 520, 620 for peripheral-initiated messages located at different locations (e.g., at the start or at the end) within a sequence of response slots. For example, FIG. 5 shows a set of reserved slots 520 for peripheral-initiated messages located at the start of a sequence of response slots 510, and FIG. 6 shows a set of reserved slots 620 for peripheral-initiated messages located at the end of a sequence of response slots 610.

In particular, FIG. 5 is a signaling diagram illustrating an example of communication transmissions 500 including a set of reserved slots 520 (e.g., r₀, r₁, r₂) for peripheral-initiated messages located at the start of a sequence of response slots 510 (e.g., r₀, r₁, r₂, r₃, r₄, r₅, r₆, r₇, r₈, r₉, r₁₀, r₁₁). In FIG. 5, a plurality of slots 530a, 530b, 510 are shown to be distributed over time (e.g., the x-axis denotes time in ms). A sequence of response slots 510 is shown to be located between two transmission slots 530a, 530b. A network device (e.g., a central device, such as an access point) may transmit an AP to one or more peripheral devices (e.g., wireless communication devices, such as ESLs) within each of the transmission slots 530a, 530b. The set of reserved slots 520 from the beginning section of the response slots 510 can be reserved for only peripheral-initiated messages transmitted by peripheral devices.

FIG. 6 is a signaling diagram illustrating an example of communication transmissions 600 including a set of reserved slots 620 (e.g., r₀, r₁, r₂) for peripheral-initiated messages located at the end of a sequence of response slots 610 (e.g., r₀, r₁, r₂, r₃, r₄, r₅, r₆, r₇, r₈, r₉, r₁₀, r₁₁). FIG. 6 shows a plurality of slots 630a, 630b, 610 distributed over time (e.g., the x-axis denotes time in ms). A sequence of response slots 610 is shown to be located between two transmission slots 630a, 630b. A network device (e.g., a central device, such as an access point) can transmit an AP to one or more peripheral devices (e.g., wireless communication devices, such as ESLs) within each of the transmission slots 630a, 630b. The set of reserved slots 620 from the end section of the response slots 610 may be reserved for only peripheral-initiated messages transmitted by peripheral devices.

A peripheral device may transmit a peripheral-initiated message in a reserved response slot out of a number of response slots reserved (e.g., the set of reserved slots 520 of FIG. 5, the set of reserved slots 620 of FIG. 6, etc.) for a group in which the peripheral device belongs, such as the wireless communication devices 420a (e.g., ESL1, ESL 2, ESL 3, ESL 4, ESL 5, ESL 6, ESL 7, ESL 8, ESL 9, ESL 10, and ESL 11) in group 1 of FIG. 4. As noted above, peripheral devices within a particular group can wake up at the same PA transmission with respect to a particular PAR train for that group. In some cases, a peripheral device belonging to a particular group may transmit a peripheral-initiated message using response slots reserved for one or more other groups of peripheral devices. For example, a peripheral device from a first group (e.g., group 1 of FIG. 4, including ESL1, ESL 2, through ESL 11) can transmit a peripheral-initiated message in a reserved response slot from a number of response slots reserved for a second group (e.g., group 2 of FIG. 4, including ESL12, ESL 13, through ESL 22) and/or other groups. By using the response slots reserved for peripheral-initiated messages, the peripheral can transmit a peripheral-initiated message to the central device (e.g., an AP) without waiting for a synchronization message for its own group.

As previously mentioned, response slots may be reserved statically by a static allocation (e.g., specific response slots can be statically reserved to be used only for peripheral-initiated messages) or dynamically by a dynamic allocation (e.g., response slots the central device is not expecting responses can be dynamically reserved to be used for peripheral-initiated messages). Details regarding static allocation of reserved response slots and dynamic allocation of reserved response slots are discussed as follows.

In one or more aspects, for a static allocation of reserved response slots for receiving peripheral-initiated messages, for any synchronization message, N number of response slots (e.g., three reserved slots in the sets of reserved slots 520, 620 as shown in FIGS. 5 and 6) may be reserved to be used for only peripheral-initiated messages (e.g., for transmissions of messages in a peripheral device to a central device direction) such that these reserved slots may not be used for transmissions of messages in a central device to a peripheral device direction. These reserved N number of response slots may be used by any peripheral device, within a group of peripheral devices, to issue a response.

The selection of which of the reserved N number of available response slots to be used for transmissions may be determined by the peripheral device itself. The peripheral device may determine which of the reserved N number of available response slots to be used by using a random strategy (e.g., randomly selecting the slot) or by following a strategy related to some information pertinent to the peripheral device itself, such as the device ID (EID), a Bluetooth Address (BD_ADDR), a private key, and/or any other characteristic of the device. Evidently, but not exclusively, a peripheral device with a command in the synchronization message from a central device (e.g., a command to transmit a response to the central device, which may be inferred from a sequence, in the synchronization message, specifying a response slot for that peripheral device to respond to the central device) is unlikely to consume any of the reserved N available response slots because the peripheral device may simply use the dedicated response slot associated with the command.

In one or more examples, the central device may add to the synchronization message a “bit” (e.g., which may be set to a “1” or a “0”) indicating whether or not the central device will scan these reserved N number of response slots for receiving any peripheral-initiated messages from any of the peripheral devices. For example, if the central device sets this additional bit to “1” in the synchronization message, this may indicate to the peripheral devices receiving the synchronization message that the central device will scan the reserved N number of response slots for receiving any possible peripheral-initiated messages. Conversely, if the central device sets this additional bit to “0” in the synchronization message (e.g., for power saving purposes, such as in the case of the central device being powered by a battery), this can indicate to the peripheral devices receiving the synchronization message that the central device will not scan the reserved N number of response slots for receiving any peripheral-initiated messages. In one or more examples, the central device may determine whether to set the additional bit to a “1” or a “0” on a per synchronization message basis or one a specific duration of time basis. In some cases, the central device may not perform the scanning when no reserved slots exist. In other aspects, no indication of scanning by the central device is provided, in which case the central device may always scan the reserved N number of response slots.

In one or more aspects, for a dynamic allocation of reserved response slots for receiving peripheral-initiated messages, a peripheral device may choose to transmit a peripheral-initiated message using a response slot that has not been indicated by a sequence in a synchronization message to be used for responses to the central device. For example, not all response slots within a subframe may be indicated by a sequence in a synchronization message to be used for responses to the central device. When a peripheral device, wanting to communicate (e.g., transmit a peripheral-initiated message) to a central device, receives a synchronization message from the central device, the peripheral device can elect (e.g., determine) to transmit a message (e.g., a peripheral-initiated message) on any response slot within the subframe that has not been indicated by the sequence in the synchronization message to be used for responses to the central device. The central device can then scan for responses in all of the response slots (e.g., including the response slots that were not indicated by the sequence in the synchronization message to be used for responses to the central device) for responses.

In one or more examples, similar to static allocation of reserved response slots, for dynamic allocation of reserved response slots, the central device may add to the synchronization message a “bit” (e.g., which may be set to a “1” or a “0”) indicating whether or not the central device is willing to spend the effort scanning the response slots that were not indicated by a sequence in the synchronization message to be used for responses to the central device. For example, if the central device sets this additional bit to “1” in the synchronization message, this may indicate to the peripheral devices receiving the synchronization message that the central device will scan the response slots that were not indicated by the sequence in the synchronization message to be used for responses to the central device. Conversely, the if the central device sets this additional bit to “0” in the synchronization message (e.g., for power saving purposes), this can indicate to the peripheral devices receiving the synchronization message that the central device will not scan the response slots that were not indicated by the sequence in the synchronization message to be used for responses to the central device. In one or more examples, the central device can determine whether to set the additional bit to a “1” or a “0” on a per synchronization message basis or one a specific duration of time basis.

For either static allocation of reserved response slots or dynamic allocation of reserved response slots, peripheral-initiated messages from two or more peripherals may clash (e.g., conflict) if the messages are transmitted in a same response slot. In one or more examples, a network device (e.g., a central device, such as an access point) and/or a network entity (e.g., a management entity) via a network device may send (e.g., transmit at a later AP synchronization message opportunity) an acknowledgement (ACK) (e.g., via a specific command) to a peripheral device to indicate that the peripheral-initiated message from the peripheral device has been successfully received by the network device and/or the network entity. In absence of receiving an ACK from the network device and/or network entity, the peripheral device can simply continue to send (e.g., transmit) the peripheral-initiated message within reserved response slots until the peripheral device receives an ACK.

An advantage of this approach, which utilizes reserved response slots within a synchronization message on a synchronized channel to transmit peripheral-initiated messages, is a reduction in spectral congestion on the legacy advertisement channel because the synchronized channel is used for transmission instead of the legacy advertisement channel. Also, separate non-connectable advertisements are not needed for the transmission of peripheral-based messages because responses to PAs in the synchronized channel are utilized instead.

Another advantage of this approach is that no changes are needed for the internal scheduling of the peripheral devices (e.g., ESLs) because this approach repurposes existing response slots on the synchronized channel for the transmission of peripheral-initiated messages. Since this approach repurposes existing response slots on the synchronized channel for the transmission of peripheral-initiated messages, the peripheral devices are able to remain in a lower power mode, even for the transmission of peripheral-based messages. The lower power mode may include a low power (LP) mode, a mode requiring only enough power to perform necessary operations, or other lower power mode of operation. For example, using the approach described herein, a peripheral device may operate in a mode where the peripheral device uses only enough power needed to track (and in some cases respond to) PAwR messages. A peripheral device operating in the LP mode can use fewer radio activities over some period of time and/or have access to fewer functionalities as compared to a normal power operation mode, which results in lower memory consumption and in turn lower power consumption.

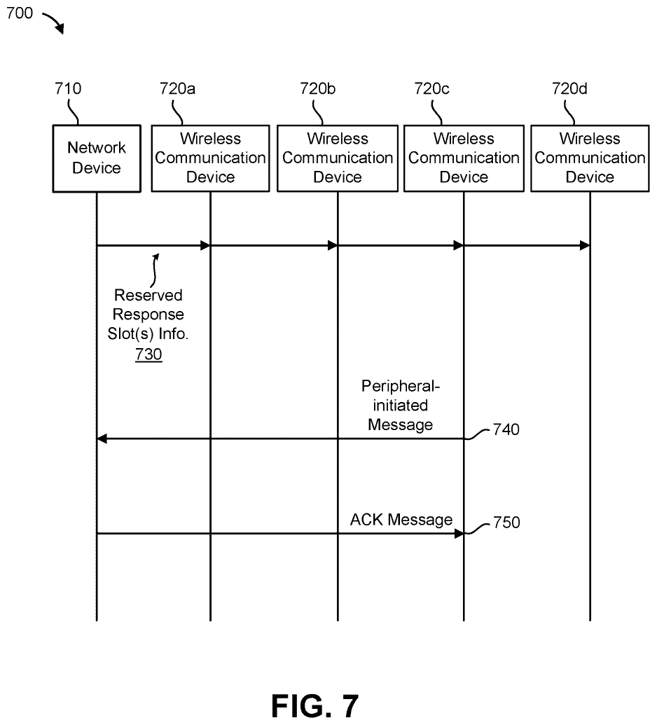

FIG. 7 shows an example of signalling between a central device and multiple peripheral devices for this approach where a peripheral-based message is transmitted utilizing a reserved response slot within a synchronization message on a synchronized channel. In particular, FIG. 7 is signaling diagram illustrating an example of communication transmissions 700 between a network device 710 and a group of wireless communication devices 720a, 720b, 720c, 720d within a PAwR network. The network device 710 can be a central device, such as an access point (AP). The wireless communication devices 720a, 720b, 720c, 720d can include peripheral devices, such as ESLs. For example, the wireless communication device 720a can be a first ESL (referred to as ESL 1), the wireless communication device 720b can be a second ESL (referred to as ESL 2), the wireless communication device 720c can be a third ESL (referred to as ESL 3), and the wireless communication device 720d can be a fourth ESL (referred to as ESL 4). In some cases, the wireless communication devices 720a, 720b, 720c, 720d can be part of a group of wireless communication devices (e.g., a group of peripheral devices, such as ESLs) that receive PAs (including synchronization messages) from the network device 710 based on a particular PAwR train of the PAwR network. For example, the group of wireless communication devices can awake (e.g., from a low power (LP) mode) at the same PA transmission with respect to the PAwR train.

As shown in FIG. 7, during operation for PAwR with capability for peripheral initiated messages over a synchronized channel, the network device 710 may provide (e.g., transmit), to the group of wireless communication devices including devices 720a, 720b, 720c, 720d, information 730 indicating reserved response slots to be used for transmission of peripheral-initiated messages, either statically (e.g., at network creation, or as part of an image) or dynamically (e.g., via a synchronization message). The network device 710 can send the information 730 to the wireless communication device 720a, the wireless communication device 720b, the wireless communication device 720c, and the wireless communication device 720d, and/or to other wireless communication devices in the group in a single transmission. The network device 710 can scan the reserved response slots for any possible peripheral-initiated messages, such as when it is indicated (e.g., via a bit set to “1”) within a synchronization message that the network device 710 will perform this scanning function.

In one illustrative example, the wireless communication device 720c (e.g., ESL 3) may determine to send (e.g., transmit) a peripheral-initiated message 740. Upon determining to send the peripheral-initiated message 740, the wireless communication device 720c can determine a slot out of the reserved response slots (e.g., reserved for a group of wireless communication devices that includes the wireless communication device 720c) for sending the peripheral-initiated message 740 to the network device 710. The wireless communication device 720c can then transmit the peripheral-initiated message 740 to the network device 710 using the determined slot from the reserved response slots on the synchronized channel. The network device 710 can receive the peripheral-initiated message 740 transmitted from the wireless communication device 720c over the synchronized channel.

In one or more examples, after the network device 710 receives the peripheral-initiated message 740, the network device 710 may transmit an acknowledgement (ACK) message 750 back to the wireless communication device 720c (e.g., ESL 3) within the next synchronization message. The wireless communication device 720c may continue to retransmit the peripheral-initiated message 740 on reserved response slots until the wireless communication device 720c receives the ACK message 750 from the network device 710.

In one or more aspects, an existing PAwR peripheral device (e.g., an ESL) can be aware of the timing (e.g., by storing information defining the timing) of the response slots for responding to an AP synchronization message from a central device (e.g., the network device 710, such as an AP). The peripheral device can utilize this information along with supplementary information (e.g., which can include the reserved response slots for peripheral-initiated messages) to select one of the slots of the reserved response slots for transmission of a peripheral-initiated message. Subsequently, the peripheral device can transmit the peripheral-initiated message using this selected slot on the synchronized channel.

As previously mentioned, in one or more aspects, the central device may add to the synchronization message one or more “bits” (e.g., which may be set to a “1” or a “0”) indicating whether or not the central device will scan (e.g., listen to) the reserved response slots. For instance, in some cases, a bit value of 1 can be included in the synchronization message for any response slot for which the central device will be scanning (e.g., listening to) and a bit value of 0 can be included for any response slot for which the central device will not be scanning. In some cases, a number of such bits can be included in a bitmask (also referred to as a bitmap) to indicate whether the central device will scan a particular response slot. The bitmask (or bitmap) can be included in the synchronization message. The bit (or a full bitmask or bitmap) can indicate to the peripheral devices (e.g., ESLs) whether or not the central device (e.g., access point) will be scanning (e.g., listening) the reserved response slots for any peripheral-initiated messages.

In one or more aspects, to ensure a successful delivery (e.g., avoid collisions of peripheral-initiated messages) of a peripheral-initiated message by a central device (e.g., the network device 710, such as an AP) from a peripheral device (e.g., an ESL), the peripheral device may repeatedly transmit the peripheral-initiated message in other reserved response slots after transmitting the peripheral-initiated message within a reserved response slot (e.g., repeatedly transmit during one or more subsequent subframes). In some examples, the peripheral device may randomly choose which slots of the reserved response slots to transmit the peripheral-initiated message.

In one or more aspects, for deployments where multiple peripheral devices (e.g., ESLs) may be expected to send peripheral-initiated messages to a central device (e.g., an access point), multiple mechanisms may be employed to avoid contention (e.g., conflicts). In one or more examples, a dynamic configuration may be utilized where a bit (e.g., referred to herein as an “AP scanning bit”) may be added to the synchronization message to indicate that the central device will be scanning (e.g., listening to) all of the reserved response slots.

In one or more examples, the AP scanning bit may be added to the synchronization message to indicate that the central device will be scanning all the reserved response slots, and that only peripheral devices with an even (or odd) number for their device ID (EID) should be transmitting peripheral-initiated messages for that subframe. In one example, an AP scanning bit set to “1” in the synchronization message can indicate that the central device will be scanning all the reserved response slots, and that only peripheral devices with an even number for their device ID (EID) should be transmitting peripheral-initiated messages for that subframe. Conversely, for example, an AP scanning bit set to “0” in the synchronization message can indicate that the central device will be scanning all the reserved response slots, and that only peripheral devices with an odd number for their device ID (EID) should be transmitting peripheral-initiated messages for that subframe.

In one or more examples, a peripheral device (e.g., ESL) may wait for an ACK in N number of subsequent (e.g., in the next two) synchronization messages for confirmation of successful delivery of a peripheral-initiated message. In cases where the peripheral device does not receive an ACK in the N number of subsequent (e.g., the next two) synchronization messages, the peripheral device may use a range-bound random subframe selection for retrying transmission of the peripheral-initiated message. For example, the peripheral device may randomly select the nth subframe out of all of the subframes (e.g., out of a range of 1-128 subframes) for retrial of transmission of the peripheral-initiated message. In one or more examples, the range of the subframes may be a lower value (e.g., less than 128 subframes) or a larger value (e.g., more than 128 subframes), depending upon the number of expected peripheral devices within the deployment.

In one or more examples, a peripheral device may combine one or more events together in an unsolicited message (e.g., a peripheral-initiated message) subject to the message length per response slot (e.g., there is limitation on the number of bits that a peripheral device can transmit within a given response slot). As such, if the peripheral device has multiple events, the peripheral device may combine the events together into a single peripheral-initiated message (e.g., subject to not exceeding the maximum message length for that particular response slot), and transmit the peripheral-initiated message in that response slot. Combining the events together into a single peripheral-initiated message allows for avoiding multiple transmissions from the peripheral device.

In case the deployment is expecting very frequent peripheral-initiated messages, the central device (e.g., access point) can allocate alternate subframes or alternate groups, which would be solely reserved for peripheral-initiated messages. For these cases, the central device (e.g., access point) would not delegate EIDs in that subframe. Alternatively, the number of response slots per frame (e.g., which may include multiple subframes) can be increased per subframe.

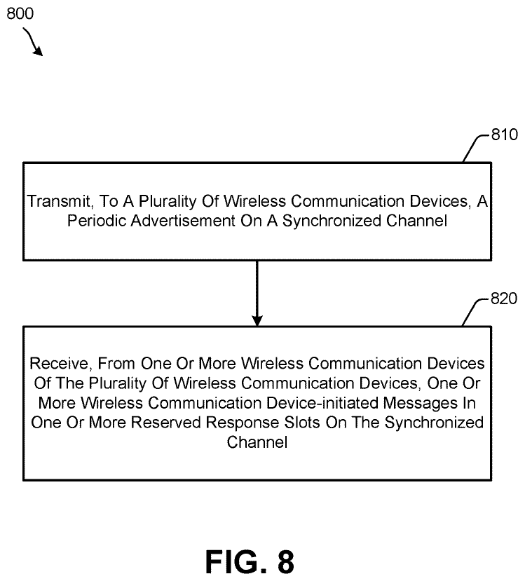

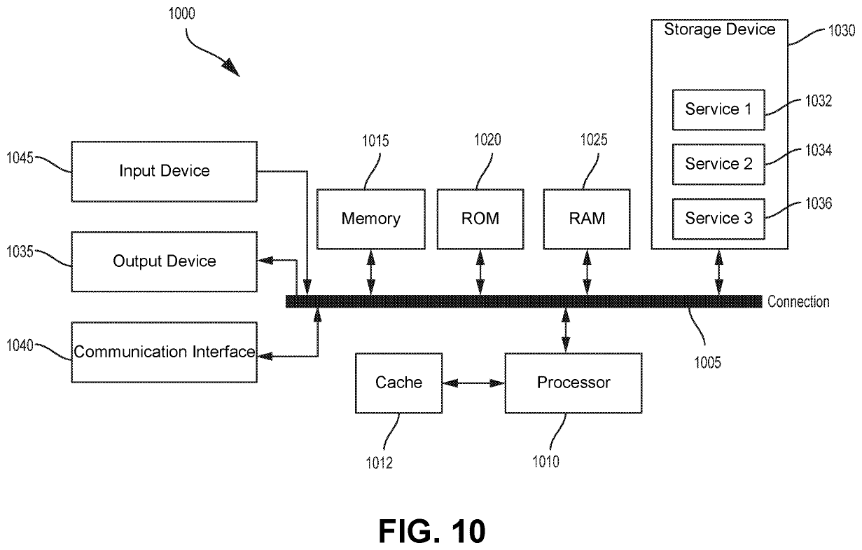

FIG. 8 is a flow chart illustrating an example of a process 800 for wireless communications utilizing methods for periodic advertising with response (PAwR) with capability for peripheral initiated messages over a synchronized channel. The process 800 can be performed by a network device (e.g., the network device 710 of FIG. 7) or by a component or system (e.g., a chipset) of the network device. The network device can include a central device, such as an AP (e.g., the AP 110 of FIG. 1 and/or the AP 410 of FIG. 4). The operations of the process 800 may be implemented as software components that are executed and run on one or more processors (e.g., processor 1010 of FIG. 10 or other processor(s)). Further, the transmission and reception of signals by the network device in the process 800 may be enabled, for example, by one or more antennas and/or one or more transceivers such as one or more wireless transceivers (e.g., using communication interface 1040 of FIG. 10).

At block 810, the network device (or component thereof) can transmit (e.g., using communication interface 1040 of FIG. 10), to a plurality of wireless communication devices, a periodic advertisement on a synchronized channel. For example, the synchronized channel is between the network device and the plurality of wireless communication devices. In some cases, the plurality of wireless communication devices are peripheral devices (e.g., ESLs).

At block 820, the network device (or component thereof) can receive (e.g., using communication interface 1040 of FIG. 10), from one or more wireless communication devices of the plurality of wireless communication devices, one or more wireless communication device-initiated messages in one or more reserved response slots on the synchronized channel. For instance, the one or more reserved response slots are reserved for transmission of the one or more wireless communication device-initiated messages by the one or more wireless communication devices. The one or more reserved response slots can be selected (e.g., by the network device) from a plurality of response slots that are available for responding to the periodic advertisement. For instance, as shown in FIG. 5, the set of reserved slots 520 for peripheral-initiated messages are selected from the sequence of response slots 510 that are available for responding to the periodic advertisement.

In some aspects, the periodic advertisement includes a synchronization message. For instance, the synchronization message can include a sequence for the plurality of wireless communication devices to respond to the periodic advertisement (e.g., the transmission 530a of FIG. 5, the transmission 630a of FIG. 6, etc.). The sequence can indicate one or more unused response slots for responding to the periodic advertisement. The one or more reserved response slots can be selected from the one or more unused response slots (e.g., the reserved response slots can be selected as the sequence of response slots 510 of FIG. 5, the sequence of response slots 610 of FIG. 6, etc.). In some cases, the synchronization message indicates whether the network device will scan the one or more reserved response slots for one of a subframe or a duration of time.

In some cases, the network device (or component thereof) can transmit (e.g., using communication interface 1040 of FIG. 10), to a wireless communication device of the plurality of wireless communication devices, an acknowledgement message confirming receipt of a wireless communication device-initiated message by the wireless communication device. For instance, to ensure delivery of the wireless communication device-initiated message to the network device, the wireless communication device may expect to receive a delivery acknowledgement in the next AP synchronization message. If an acknowledgement is not received, the wireless communication device can retry sending (e.g., by re-transmitting) the peripheral-initiated message in a different reserved response slot.

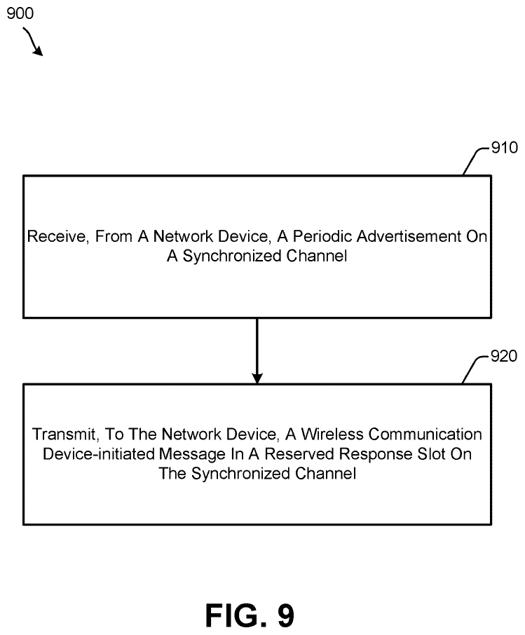

FIG. 9 is a flow chart illustrating an example of a process 900 for wireless communications utilizing methods for periodic advertising with response (PAwR) with capability for peripheral initiated messages over a synchronized channel. The process 900 can be performed by a wireless communication device (e.g., wireless communication device 120 of FIG. 1, which can be a peripheral device such as the ESL 1 420a of FIG. 4) or by a component or system (e.g., a chipset) of the wireless communication device. The operations of the process 900 may be implemented as software components that are executed and run on one or more processors (e.g., processor 1010 of FIG. 10 or other processor(s)). Further, the transmission and reception of signals by the wireless communications device in the process 900 may be enabled, for example, by one or more antennas and/or one or more transceivers such as one or more wireless transceivers (e.g., using communication interface 1040 of FIG. 10).

At block 910, the wireless communication device (or component thereof) may receive (e.g., using communication interface 1040 of FIG. 10), from a network device, a periodic advertisement on a synchronized channel. For example, the synchronized channel is between the network device and a plurality of wireless communication devices that includes the wireless communication device. The network device can include a central device, such as an AP (e.g., the AP 110 of FIG. 1 and/or the AP 410 of FIG. 4).

At block 920, the wireless communication device (or component thereof) may transmit (e.g., using communication interface 1040 of FIG. 10), to the network device, a wireless communication device-initiated message in a reserved response slot on the synchronized channel. For instance, the reserved response slot is reserved for transmission of one or more wireless communication device-initiated messages by one or more wireless communication devices. The reserved response slot (and other reserved response slots) can be selected (e.g., by the network device) from a plurality of response slots that are available for responding to the periodic advertisement. For instance, as shown in FIG. 5, the set of reserved slots 520 for peripheral-initiated messages are selected from the sequence of response slots 510 that are available for responding to the periodic advertisement.

In some aspects, the periodic advertisement includes a synchronization message. For instance, the synchronization message can include a sequence for the plurality of wireless communication devices to respond to the periodic advertisement (e.g., the transmission 530a of FIG. 5, the transmission 630a of FIG. 6, etc.). The sequence can indicate one or more unused response slots for responding to the periodic advertisement. The reserved response slot (and other reserved response slots) can be selected from the one or more unused response slots (e.g., the reserved response slots can be selected as the sequence of response slots 510 of FIG. 5, the sequence of response slots 610 of FIG. 6, etc.). In some cases, the synchronization message indicates whether the network device will scan the reserved response slot (and other reserved response slots) for one of a subframe or a duration of time.

As noted above, in some cases to ensure delivery of the wireless communication device-initiated message to the network device, the wireless communication device may expect to receive a delivery acknowledgement in the next AP synchronization message. If an acknowledgement is not received, the wireless communication device can retry sending (e.g., by re-transmitting) the peripheral-initiated message in a different reserved response slot. In one example, the wireless communication device (or component thereof) may receive, from the network device, an acknowledgement message confirming receipt of the wireless communication device-initiated message by the wireless communication device. In another example, the wireless communication device (or component thereof) may determine that an acknowledgement message confirming receipt of the wireless communication device-initiated message has not been received from the network device. Based on determining that the acknowledgement message has not been received from the network device, the wireless communication device (or component thereof) can retransmit, to the network device, the wireless communication device-initiated message in an additional reserved response slot on the synchronized channel.

The network device and/or wireless communication device may include various components, such as one or more input devices, one or more output devices, one or more processors, one or more microprocessors, one or more microcomputers, one or more cameras, one or more sensors, one or more receivers, transmitters, and/or transceivers, and/or other component(s) that are configured to carry out the steps of processes described herein.

The components of the network device configured to perform the process 800 of FIG. 8 and/or the wireless communication device configured to perform the process 900 of FIG. 9 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 800 and the process 900 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 800, process 900, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a block diagram illustrating an example of a computing system 1000, which may be employed by the disclosed systems and techniques for periodic advertising with response (PAwR) with capability for peripheral initiated messages (e.g., initiated by one or more ESLs) over a synchronized channel. In particular, FIG. 10 illustrates an example of computing system 1000, which can be, for example, any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some aspects, computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1000 includes at least one processing unit (CPU or processor) 1010 and connection 1005 that communicatively couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, etc. Computing system 1000 can also include output device 1035, which can be one or more of a number of output mechanisms. In some instances, multimodal systems can enable a user to provide multiple types of input/output to communicate with computing system 1000.

Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1040 may also include one or more range sensors (e.g., LIDAR sensors, laser range finders, RF radars, ultrasonic sensors, and infrared (IR) sensors) configured to collect data and provide measurements to processor 1010, whereby processor 1010 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1 ) cache, Level 2 (L2 ) cache, Level 3 (L3) cache, Level 4 (L4 ) cache, Level 5 (L5 ) cache, or other (L #) cache), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some aspects, a hardware service that performs a particular function can include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:
Aspect 1. A network device for wireless communication, the network device comprising: at least one memory; and at least one processor coupled to the at least one memory and configured to: output, for transmission to a plurality of wireless communication devices, a periodic advertisement on a synchronized channel; and receive, from one or more wireless communication devices of the plurality of wireless communication devices, one or more wireless communication device-initiated messages in one or more reserved response slots on the synchronized channel.
Aspect 2. The network device of Aspect 1, wherein the network device is an access point.
Aspect 3. The network device of any of Aspects 1 or 2, wherein the plurality of wireless communication devices are peripheral devices.
Aspect 4. The network device of any of Aspects 1 to 3, wherein the synchronized channel is between the network device and the plurality of wireless communication devices.
Aspect 5. The network device of any of Aspects 1 to 4, wherein the one or more reserved response slots are reserved for transmission of the one or more wireless communication device-initiated messages by the one or more wireless communication devices.
Aspect 6. The network device of any of Aspects 1 to 5, wherein the one or more reserved response slots are selected from a plurality of response slots for responding to the periodic advertisement.
Aspect 7. The network device of any of Aspects 1 to 6, wherein the periodic advertisement comprises a synchronization message.
Aspect 8. The network device of Aspect 7, wherein the synchronization message comprises a sequence for the plurality of wireless communication devices to respond to the periodic advertisement.
Aspect 9. The network device of Aspect 8, wherein the sequence indicates one or more unused response slots for responding to the periodic advertisement.
Aspect 10. The network device of Aspect 9, wherein the one or more reserved response slots are selected from the one or more unused response slots for responding to the periodic advertisement.
Aspect 11. The network device of any of Aspects 7 to 10, wherein the synchronization message indicates whether the network device will scan the one or more reserved response slots for one of a subframe or a duration of time.
Aspect 12. The network device of any of Aspects 1 to 11, wherein the at least one processor is configured to: output, for transmission to a wireless communication device of the plurality of wireless communication devices, an acknowledgement message confirming receipt of a wireless communication device-initiated message by the wireless communication device.
Aspect 13. A wireless communication device for wireless communication, the wireless communication device comprising: at least one memory; and at least one processor coupled to the at least one memory and configured to: receive, from a network device, a periodic advertisement on a synchronized channel; and output, for transmission to the network device, a wireless communication device-initiated message in a reserved response slot on the synchronized channel.
Aspect 14. The wireless communication device of Aspect 13, wherein the wireless communication device is a peripheral device.
Aspect 15. The wireless communication device of any of Aspects 13 or 14, wherein the network device is an access point.
Aspect 16. The wireless communication device of any of Aspects 13 to 15, wherein the synchronized channel is between the network device and a plurality of wireless communication devices.
Aspect 17. The wireless communication device of any of Aspects 13 to 16, wherein the reserved response slot is reserved for transmission of one or more wireless communication device-initiated messages by one or more wireless communication devices.
Aspect 18. The wireless communication device of any of Aspects 13 to 17, wherein the reserved response slot is selected from a plurality of response slots for responding to the periodic advertisement.
Aspect 19. The wireless communication device of any of Aspects 13 to 18, wherein the periodic advertisement comprises a synchronization message.
Aspect 20. The wireless communication device of Aspect 19, wherein the synchronization message comprises a sequence for a plurality of wireless communication devices to respond to the periodic advertisement.
Aspect 21. The wireless communication device of Aspect 20, wherein the sequence indicates one or more unused response slots for responding to the periodic advertisement.
Aspect 22. The wireless communication device of Aspect 21, wherein the reserved response slot is selected from the one or more unused response slots for responding to the periodic advertisement.
Aspect 23. The wireless communication device of any of Aspects 19 to 22, wherein the synchronization message indicates whether the network device will scan one or more reserved response slots for one of a subframe or a duration of time.
Aspect 24. The wireless communication device of any of Aspects 13 to 23, wherein the at least one processor is configured to: receive, from the network device, an acknowledgement message confirming receipt of the wireless communication device-initiated message by the wireless communication device.
Aspect 25. The wireless communication device of any of Aspects 13 to 23, wherein the at least one processor is configured to: determine that an acknowledgement message confirming receipt of the wireless communication device-initiated message has not been received from the network device; and based on determining that the acknowledgement message has not been received from the network device, output, for re-transmission to the network device, the wireless communication device-initiated message in an additional reserved response slot on the synchronized channel.
Aspect 26. A method of wireless communication performed at a network device, the method comprising: transmitting, by the network device to a plurality of wireless communication devices, a periodic advertisement on a synchronized channel; and receiving, by the network device from one or more wireless communication devices of the plurality of wireless communication devices, one or more wireless communication device-initiated messages in one or more reserved response slots on the synchronized channel.
Aspect 27. The method of Aspect 26, wherein the network device is an access point.
Aspect 28. The method of any of Aspects 26 or 27, wherein the plurality of wireless communication devices are peripheral devices.
Aspect 29. The method of any of Aspects 26 to 28, wherein the synchronized channel is between the network device and the plurality of wireless communication devices.
Aspect 30. The method of any of Aspects 26 to 29, wherein the one or more reserved response slots are reserved for transmission of the one or more wireless communication device-initiated messages by the one or more wireless communication devices.
Aspect 31. The method of any of Aspects 26 to 30, wherein the one or more reserved response slots are selected from a plurality of response slots for responding to the periodic advertisement.
Aspect 32. The method of any of Aspects 26 to 31, wherein the periodic advertisement comprises a synchronization message.
Aspect 33. The method of Aspect 32, wherein the synchronization message comprises a sequence for the plurality of wireless communication devices to respond to the periodic advertisement.
Aspect 34. The method of Aspect 33, wherein the sequence indicates one or more unused response slots for responding to the periodic advertisement.
Aspect 35. The method of Aspect 34, wherein the one or more reserved response slots are selected from the one or more unused response slots for responding to the periodic advertisement.
Aspect 36. The method of any of Aspects 32 to 35, wherein the synchronization message indicates whether the network device will scan the one or more reserved response slots for one of a subframe or a duration of time.
Aspect 37. The method of any of Aspects 26 to 36, further comprising: transmitting, to a wireless communication device of the plurality of wireless communication devices, an acknowledgement message confirming receipt of a wireless communication device-initiated message by the wireless communication device.
Aspect 38. A method of wireless communication performed at wireless communication device, the method comprising: receiving, by the wireless communication device from a network device, a periodic advertisement on a synchronized channel; and transmitting, by the wireless communication device to the network device, a wireless communication device-initiated message in a reserved response slot on the synchronized channel.
Aspect 39. The method of Aspect 38, wherein the wireless communication device is a peripheral device.
Aspect 40. The method of any of Aspects 38 or 39, wherein the network device is an access point.
Aspect 41. The method of any of Aspects 38 to 40, wherein the synchronized channel is between the network device and a plurality of wireless communication devices.
Aspect 42. The method of any of Aspects 38 to 41, wherein the reserved response slot is reserved for transmission of one or more wireless communication device-initiated messages by wireless communication device.
Aspect 43. The method of any of Aspects 38 to 42, wherein the reserved response slot is selected from a plurality of response slots for responding to the periodic advertisement.
Aspect 44. The method of any of Aspects 38 to 43, wherein the periodic advertisement comprises a synchronization message.
Aspect 45. The method of Aspect 44, wherein the synchronization message comprises a sequence for a plurality of wireless communication devices to respond to the periodic advertisement.
Aspect 46. The method of Aspect 45, wherein the sequence indicates one or more unused response slots for responding to the periodic advertisement.
Aspect 47. The method of Aspect 46, wherein the reserved response slot is selected from the one or more unused response slots for responding to the periodic advertisement.
Aspect 48. The method of any of Aspects 44 to 47, wherein the synchronization message indicates whether the network device will scan one or more reserved response slots for one of a subframe or a duration of time.
Aspect 49. The method of any of Aspects 38 to 48, further comprising: receiving, from the network device, an acknowledgement message confirming receipt of the wireless communication device-initiated message by the wireless communication device.
Aspect 50. The method of any of Aspects 38 to 48, further comprising: determining that an acknowledgement message confirming receipt of the wireless communication device-initiated message has not been received from the network device; and based on determining that the acknowledgement message has not been received from the network device, re-transmitting, to the network device, the wireless communication device-initiated message in an additional reserved response slot on the synchronized channel.
Aspect 51. A non-transitory computer-readable storage medium having stored thereon instructions which, when executed by one or more processors, cause the one or more processors to perform any of the operations of any of Aspects 26 to 37.
Aspect 52. An apparatus comprising means for performing any of the operations of any of Aspects 26 to 37.
Aspect 53. A non-transitory computer-readable storage medium having stored thereon instructions which, when executed by one or more processors, cause the one or more processors to perform any of the operations of any of Aspects 38 to 50.
Aspect 54. An apparatus comprising means for performing any of the operations of any of Aspects 38 to 50.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

1. A network device for wireless communication, the network device comprising:
at least one memory; and
at least one processor coupled to the at least one memory and configured to:
output, for transmission to a plurality of wireless communication devices, a periodic advertisement on a synchronized channel; and
receive, from one or more wireless communication devices of the plurality of wireless communication devices, one or more wireless communication device-initiated messages in one or more reserved response slots on the synchronized channel.

2. The network device of claim 1, wherein the network device is an access point.

3. The network device of claim 1, wherein the plurality of wireless communication devices are peripheral devices.

4. The network device of claim 1, wherein the synchronized channel is between the network device and the plurality of wireless communication devices.

5. The network device of claim 1, wherein the one or more reserved response slots are reserved for transmission of the one or more wireless communication device-initiated messages by the one or more wireless communication devices.

6. The network device of claim 1, wherein the one or more reserved response slots are selected from a plurality of response slots for responding to the periodic advertisement.

7. The network device of claim 1, wherein the periodic advertisement comprises a synchronization message.

8. The network device of claim 7, wherein the synchronization message comprises a sequence for the plurality of wireless communication devices to respond to the periodic advertisement.

9. The network device of claim 8, wherein the sequence indicates one or more unused response slots for responding to the periodic advertisement.

10. The network device of claim 9, wherein the one or more reserved response slots are selected from the one or more unused response slots for responding to the periodic advertisement.

11. The network device of claim 7, wherein the synchronization message indicates whether the network device will scan the one or more reserved response slots for one of a subframe or a duration of time.

12. The network device of claim 1, wherein the at least one processor is configured to:
output, for transmission to a wireless communication device of the plurality of wireless communication devices, an acknowledgement message confirming receipt of a wireless communication device-initiated message by the wireless communication device.

13. A wireless communication device for wireless communication, the wireless communication device comprising:
at least one memory; and
at least one processor coupled to the at least one memory and configured to:
receive, from a network device, a periodic advertisement on a synchronized channel; and
output, for transmission to the network device, a wireless communication device-initiated message in a reserved response slot on the synchronized channel.

14. The wireless communication device of claim 13, wherein the wireless communication device is a peripheral device.

15. The wireless communication device of claim 13, wherein the network device is an access point.

16. The wireless communication device of claim 13, wherein the synchronized channel is between the network device and a plurality of wireless communication devices.

17. The wireless communication device of claim 13, wherein the reserved response slot is reserved for transmission of one or more wireless communication device-initiated messages by one or more wireless communication devices.

18. The wireless communication device of claim 13, wherein the reserved response slot is selected from a plurality of response slots for responding to the periodic advertisement.

19. The wireless communication device of claim 13, wherein the periodic advertisement comprises a synchronization message.

20. The wireless communication device of claim 19, wherein the synchronization message comprises a sequence for a plurality of wireless communication devices to respond to the periodic advertisement.

21-30. (canceled)
